(19) United States
(12) Patent Application Publication
(10) Pub. No.: US 2006/0225262 A1
(43) Pub. Date: Oct. 12, 2006

(54) Custom vehicle door hinge pin and bushing installation kit

(76) Inventor: Francisco Javier Federico, Estes Park, CO (US)

Correspondence Address: BARBER LEGAL, P.O. BOX 16220, GOLDEN, CO, 80402-6004, US

(21) Appl. No.: 11/103,287

(22) Filed: Apr. 8, 2005

(51) Int. Cl. B23P 19/04

(52) U.S. Cl. 29/257

(57) ABSTRACT

The kit of the invention uses a truss with a draw bolt, washers and a nut to draw or press a bushing into the door supports, and a strong frame with another draw bolt to press the hinge pin into the bushings. The distances between components of the kit and the lengths, diameters and separations of the various kit parts are carefully dimensioned to the lengths, diameters and separation distances of the vehicle supports, bushings and hinge pin, so that each part fits with the corresponding auto part. Thus, the present invention teaches that an installation kit may be inexpensively assembled yet customized for a single make or even model of vehicle.

### FIELD OF THE INVENTION

This invention relates generally to automobile repair tools and specifically to custom installers for vehicle door hinges.

### CROSS-REFERENCE TO RELATED APPLICATIONS

N/A

### STATEMENT REGARDING FEDERALLY FUNDED RESEARCH

This invention was not made under contract with an agency of the US Government, nor by any agency of the US Government.

### BACKGROUND OF THE INVENTION

Vehicle door hinges require a good deal of engineering. The vehicle door hinge must support the fair weight of the door from one end when the door is opened, and yet it must also allow an easy open and close of the door. The result is that vehicle doors must be constructed using tough hinges of durable metal, and the hinges must be constructed to a high tolerance, that is, the door hinge components must have an extremely tight fit to each another.

The support on the door side forms one half of the hinge body, and the frame side support forms the other half of the hinge body. They are held together by a hinge pin that passes through holes in both the door side support and the hinge support on the vehicle frame. In order to smooth opening and closing and in order to provide a tighter fit, bushings are usually used in the door side support holes, or in some models of cars in the vehicle frame side support holes, or in both.

The bushing and the hinge pin are extremely difficult to install. The tolerances (the fit) of the pin and the bushings are very precise and the bushing and pin will not simply slide into place. In fact, a great deal of force is required to force the bushings into the support holes, and then to force the pin through the bushing holes. At the same time, the mechanic has to make sure that the vehicle door is properly supported in the correct place so that the holes on the door support and the holes on the frame support line up. Applying a great deal of force to the bushing or hinge pin can easily move the door out of alignment so the holes don't line up right any more.

Mechanics try various ways of forcing the bushings and hinge pins through the supports. Obviously, hammering will work to a certain extent. However, this has a lot of disadvantages. First, the hammering may harm the hinge pin, the bushing, the support on the door, the support on the vehicle frame, or some other part of the vehicle. Also, hammering is likely to push the door out of alignment if the mechanic has not very strongly attached it in the right place. Most importantly, the hammering doesn't work all that well because a lot of the time, the mechanic has trouble even getting the hammer to a place where it can even be used at all.

C-clamps could be used, and would eliminate some of the problems of a hammer. However, C-clamps come in standard sizes that have no relationship to the size of the door hinges. As a result, a mechanic will have trouble getting a C-clamp to attach to the supports and push on the bushing or pin. Even if that is successful, the C-clamp will block the bottom of the hole when the pin or bushing needs to push through and come out the other side. The C-clamp will then be in the way. The result is that the hinge pin or bushing will be stuck only part way through the supports and then the mechanic must go back to hammering on the hinge pin.

It would be much better to provide an installation kit which is customized to the problem of fitting a tool into the space, allows the hinge pin and bushing to extend right through the hinge and back out without getting in the way, and also allows the mechanic to easily and gently apply force to the bushing/pin to force it into position without damaging anything.

### SUMMARY OF THE INVENTION

General Summary

The present invention actually does provide an installation kit which is customized to the problem of fitting a tool into the space between the supports of the hinge, and which actually allows the hinge pin and bushing to extend right through the hinge and back out without letting the tools get in the way, and also really allows the mechanic to easily and gently apply force to the bushing/pin to force it into position without damaging any of the various parts of the vehicle: door, door supports, body, body supports, bushing, hinge pin.

The kit of the invention uses a truss with a draw bolt, washers and a nut to draw or press a bushing into the door supports, and a strong frame with another draw bolt to press the hinge pin into the bushings. The distances between components of the kit and the lengths, diameters and separations of the various kit parts are carefully dimensioned to the lengths; diameters and separation distances of the vehicle supports, bushings and hinge pin, so that each part fits with the corresponding auto part. Thus, the present invention teaches that an installation kit may be inexpensively assembled yet customized for a single make or even model of vehicle.

Summary in Reference to Claims

It is therefore a first aspect, advantage, objective and embodiment of the present invention to provide a custom hinge bushing and pin installation kit a custom hinge bushing and pin installation kit for use on a particular make of automobile hinge, the automobile hinge having an upper door support having a first hole therethrough, and having a lower door support having a second hole therethrough, and having an upper frame support having a third hole therethrough, and having a lower frame support having a fourth hole therethrough, and having an upper bushing having a fifth hole therethrough, and having a lower bushing having a sixth hole therethrough, and having at least one hinge pin having a hinge pin length and having an outer diameter, the upper and lower supports being separated by a first distance, the first, second, third and fourth holes having a first diameter, the upper and lower bushings having an outer diameter almost exactly equal to the first diameter, the upper and lower bushings having a inner diameter almost exactly equal to the outer diameter of the hinge pin, in which the hinge bushing and pin installation kit comprises:
a) a bushing installation tool having a bushing draw bolt, at least one flat washer; a nut, and a truss piece;
b) the bushing draw bolt having a threaded end and a head end;
c) the nut threaded upon the bushing draw bolt threaded end;
d) the at least one flat washer disposed around the bushing draw bolt between the nut and the head end, the flat washer having a diameter greater than the inner diameter of the bushings;
e) the truss piece having a top portion and two side portions extending from the edges of the top portion at an angle substantially perpendicular to the top portion, and having a hole passing through the top portion, the truss piece hole disposed around the bushing draw bolt between the at least one flat washer and the bushing draw bolt head, the truss piece disposed with the side portions extending towards the at least one flat washer;
f) the side portions of the truss piece being separated by a distance greater than the outer diameter of the two bushings; the truss piece being smaller than the first distance between the upper and lower supports;
g) a hinge pin installation tool having a strong frame and a hinge pin draw bolt;
h) the strong frame having a first end having an internally threaded aperture and a second end having a receiving aperture, the receiving aperture having a diameter larger than the outer diameter of the hinge pin; the first and second ends being separated by a distance and
i) the hinge pin draw bolt having a threaded end and a head end, the threaded end threaded through the internally threaded aperture of the first end of the strong frame, the hinge pin draw bolt having a length greater than the hinge pin length.

It is therefore a second aspect, advantage, objective and embodiment of the present invention to provide a custom hinge bushing and pin installation kit wherein the strong frame further comprises:
h1) a first end arm terminating in the first end, a second end arm terminating in the second end, and a cross piece connecting the first and second end arms.

It is therefore a third aspect, advantage, objective and embodiment of the present invention to provide a custom hinge bushing and pin installation kit wherein the strong frame further comprises a triangular cross-section of steel construction along the first end arm, the second end arm and the cross piece.

It is therefore a fourth aspect, advantage, objective and embodiment of the present invention to provide a custom hinge bushing and pin installation kit for use on a particular make of automobile hinge, the automobile hinge having an upper door support having a first hole therethrough, and having a lower door support having a second hole therethrough, and having an upper frame support having a third hole therethrough, and having a lower frame support having a fourth hole therethrough, and having an upper bushing having a fifth hole therethrough, and having a lower bushing having a sixth hole therethrough, and having at least one hinge pin having a hinge pin length and having an outer diameter, the upper and lower supports being separated by a first distance, the first, second, third and fourth holes having a first diameter, the upper and lower bushings having an outer diameter almost exactly equal to the first diameter, the upper and lower bushings having a inner diameter almost exactly equal to the outer diameter of the hinge pin, in which the hinge bushing and pin installation kit comprises:
a) a bushing installation tool having a bushing draw bolt, at least one flat washer; a nut, and a truss piece;
b) the bushing draw bolt having a threaded end and a head end;
c) the truss piece having a top portion and two side portions extending from the edges of the top portion at an angle substantially perpendicular to the top portion, and having a threaded hole passing through the top portion, the truss piece threaded upon the bushing draw bolt at the bushing draw bolt threaded end, the truss piece disposed with the side portions extending towards the at least one flat washer;
d) the at least one flat washer disposed around the bushing draw bolt between the truss piece and the head end, the flat washer having a diameter greater than the inner diameter of the bushings;
e) the side portions of the truss piece being separated by a distance greater than the outer diameter of the two bushings; the truss piece being smaller than the first distance between the upper and lower supports;
f) a hinge pin installation tool having a strong frame and a hinge pin draw bolt;
g) the strong frame having a first end having an internally threaded aperture and a second end having a receiving aperture, the receiving aperture having a diameter larger than the outer diameter of the hinge pin; the first and second ends being separated by a distance and
h) the hinge pin draw bolt having a threaded end and a head end, the threaded end threaded through the internally threaded aperture of the first end of the strong frame, the hinge pin draw bolt having a length greater than the hinge pin length.

### BRIEF DESCRIPTION OF THE DRAWINGS

FIG. 1 is a perspective view of a vehicle door and the bushing installation tool of the invention in a first phase of use.

FIG. 2 is a perspective view of a vehicle door and vehicle frame, with the hinge pin installation tool in a second phase of use.

FIG. 3 is a side view of the hinge pin installation tool of the invention.

FIG. 4 is an end view of the hinge pin installation tool of the invention.

FIG. 5 is a top view of the hinge pin installation tool of the invention.

FIG. 6 is a side view of a second embodiment of the hinge pin installation tool of the invention, without the hinge pin draw bolt.

FIG. 7 is an end view of the second embodiment of the hinge pin installation tool of the invention, without the hinge pin draw bolt.

FIG. 8 is a top view of the hinge pin installation tool of the invention in the second embodiment, without the hinge pin draw bolt.

FIG. 9 is an end view of the truss piece of the bushing installation tool of the invention.

FIG. 10 is a cross-sectional side view of the truss piece of the bushing installation tool of the invention.

FIG. 11 is a bottom plan view of the truss piece of the bushing installation tool of the invention.

FIG. 12 is a front view of the assembled bushing installation tool of the invention in an alternative embodiment having nut and bolt reversed in orientation.

FIG. 13 is a side view of the assembled bushing installation tool of the invention in the alternative embodiment.

FIG. 14 is a bottom view of the assembled bushing installation tool of the invention in the alternative embodiment.

### INDEX OF REFERENCE NUMBERS

Vehicle Parts

| | |
|---|---|
| Upper door support | 102 |
| Lower door support | 104 |
| Upper frame support | 106 |
| Lower frame support | 108 |
| First hole | 110 |
| Second hole | 112 |
| Third hole | 114 |
| Fourth hole | 116 |
| Fifth hole | 118 |
| Sixth hole | 120 |
| Upper bushing | 122 |
| Lower bushing | 124 |
| Hinge pin | 126 |

Dimensions

| | |
|---|---|
| Hinge pin length | 202 |
| Hinge pin outer diameter | 204 |
| First distance | 206 |
| First diameter | 208 |
| Bushing outer diameter | 210 |
| Bushing inner diameter | 212 |
| Washer diameter | 214 |
| Separation distance of truss side pieces | 216 |
| Truss piece height | 218 |
| Receiving aperture diameter | 220 |
| Hinge pin installation tool end separation distance | 222 |
| Hinge pin draw bolt length | 224 |

Hinge Pin Installation Tool

| | |
|---|---|
| Hinge pin installation tool | 302 |
| Frame | 304 |
| Hinge pin draw bolt | 306 |
| First end | 308 |
| Second end | 310 |
| First arm | 312 |
| Second arm | 314 |
| Cross piece | 316 |
| Threaded aperture | 318 |
| Receiving aperture | 320 |
| Hinge pin draw bolt threaded end | 322 |
| Hinge pin draw bolt head end | 324 |

Bushing Installation Tool

| | |
|---|---|
| Bushing installation tool | 402 |
| Bushing draw bolt | 404 |
| Washer | 406 |
| Nut | 408 |
| Truss piece | 410 |
| Bushing draw bolt threaded end | 412 |
| Bushing draw bolt head end | 414 |
| Truss piece top portion | 416 |
| Truss piece side portions | 418, 420 |
| Top portion edges | 422 |
| Top portion hole | 424 |
| Second washer | 426 |

Bushing Tool Alternative Embodiment

| | |
|---|---|
| Washer | 506 |
| Nut | 508 |
| Threaded end | 512 |
| Head end | 514 |

### DETAILED DESCRIPTION

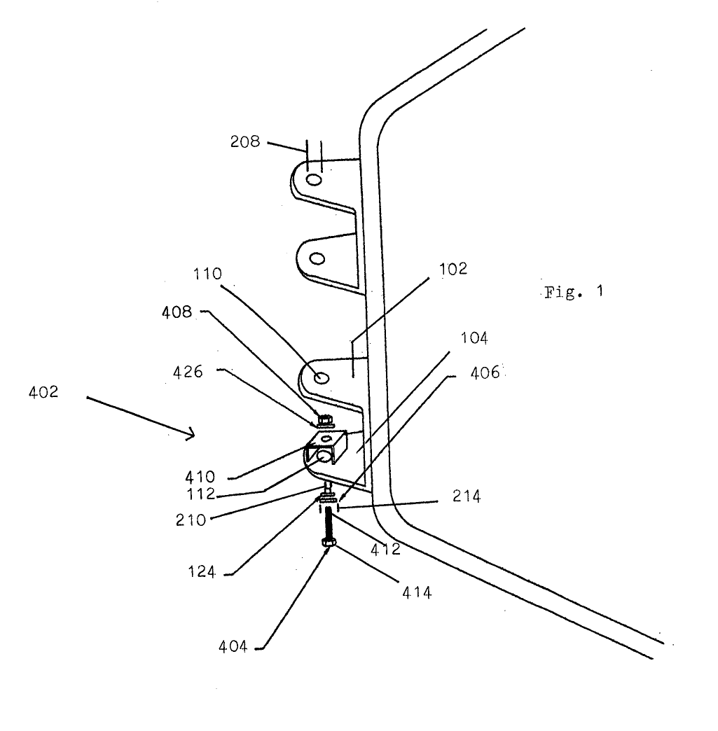

FIG. 1 is an exploded/perspective view of a vehicle door and the bushing installation tool of the invention in a first phase of use: installing the bushings into the door side supports. (In other models or makes of automobile, the bushings may go into the frame side supports.)

Upper door support 102 and lower door support 104 are upper and lower parts of a single over all door support bracket, another door support bracket may be seen higher up on the vehicle door, without numbers on it. It will be understood that the same apparatus and procedures which are used on the numbered door support 102, 104 may be used on the other door support bracket as well, but for convenience only door support 102, 104 will be discussed. Upper door support 102 (the top end of the lower door support bracket) has first hole 110 passing through it, while lower door support 104 has second hole 112 therethrough. These holes have a first diameter 208. The vehicle manufacturer uses these to hold two bushings, one in each hole, such as lower bushing 124 shown in the diagram. During work on the door, one bushing at a time is handled by the mechanic, so the upper bushing is not shown. Also, two more bushings would be used on the un-numbered door support bracket higher up on the door, for a total of four bushings per vehicle door. For clarity, one bushing 124 is shown during the course of work and the other three omitted from the diagram.

Bushing outer diameter 210 will exactly through hole 112 in most models of vehicles, however, installing the bushing is extremely difficult as the tolerance is close to zero: the bushing must be extremely tight in the hole. Washer diameter 214 is larger than the bushing for convenient handling, however, the washer hole is small enough that the washer still engages the bushing during use.

Bushing installation tool 402 is the first portion of the kit which used during the installation process, as the bushings must be installed before the door hinge pin. Bushing draw bolt 404 has on it washer 406 and nut 408, and may have in embodiments second washer 426. These are disposed around the bushing draw bolt threaded end 412 between the nut 408 and the bushing draw bolt head end 414. It will be appreciated that the low cost of the kit allows it to be customized: one kit for one make or model of vehicle. Thus, bushing draw bolt 404 can have length specifically adapted to the vehicle: the length of bushing draw bolt 404 may be somewhat less than the distance separating the upper and lower parts of the door support (102, 104).

Truss piece 410 is also disposed (by a hole through the truss piece) about the threaded end 412 of the bushing draw bolt. Because truss piece 410 sits apart from the door support by a short distance, the bushing 124 may be drawn (pushed) up through hole 112 so that some small part of bushing 124 may project up above the hole 112. Without truss piece 410, the bushing would be unable to fully pass into the hole 112: it would be stopped by the nut 408 or washer 426.

In use, it may be seen that tightening head 414 causes the assembly to constrict and become tighter against nut 408 at the opposite end of the draw bolt 404. The bushing caught in between is forced through the hole 112 in a steady, reliable manner. This is in great contrast to the frustration otherwise experienced in trying to hammer or push the bushing through the hole.

FIG. 2 is a perspective view of a vehicle door and vehicle frame, with the hinge pin installation tool in a second phase of use. At this second phase of operations, two bushings 122, 124 have been installed in holes 110, 112, (and two more bushings installed in the higher door support bracket). Upper bushing 122 and lower bushing 124 (for clarity, shown on the un-numbered upper bracket but actually invisible behind the hinge pin tool) have fifth and sixth holes 118, 120 passing through them. These bushing inner diameters 212 are somewhat smaller (by the thickness of the bushing) from the first diameter 208, but are almost exactly the same diameter as the hinge pin outer diameter 204 of hinge pin 126. The first distance 206, the distance between a pair of upper and lower supports of one bracket, is related to the hinge pin length 202: normally vehicle manufacturers make the hinge pin length 202 approximately the same, or slightly greater than, the first distance 206.

It will be understood that the diameters of the parts of the tools of the invention relate in important ways to the diameters of the parts of the vehicle, and that the lengths of the parts of the tools of the invention must relate to the distances of the door hinge components. Thus, the sizes of the parts must be carefully dimensioned to the dimensions of the vehicle parts, one important aspect of the invention which in turn relates to the low cost of making of the invention: the parts of the invention may be made inexpensively and thus may be customized for individual makes or models of vehicle.

The second phase of operations, installation of the hinge pin 126, requires that the hinge pin pass through both of two bushings, and also pass through the holes on the frame brackets: upper frame support 106 and lower frame support 108, which have respective holes third hole 114 and fourth hole 116.

In FIG. 2, the hinge pin has been passed through lower bushing 120 (again, actually present in the lower bracket lower support, which is concealed, and so the bushing is depicted in the upper bracket lower support) and is now ready to pass through upper bushing 122.

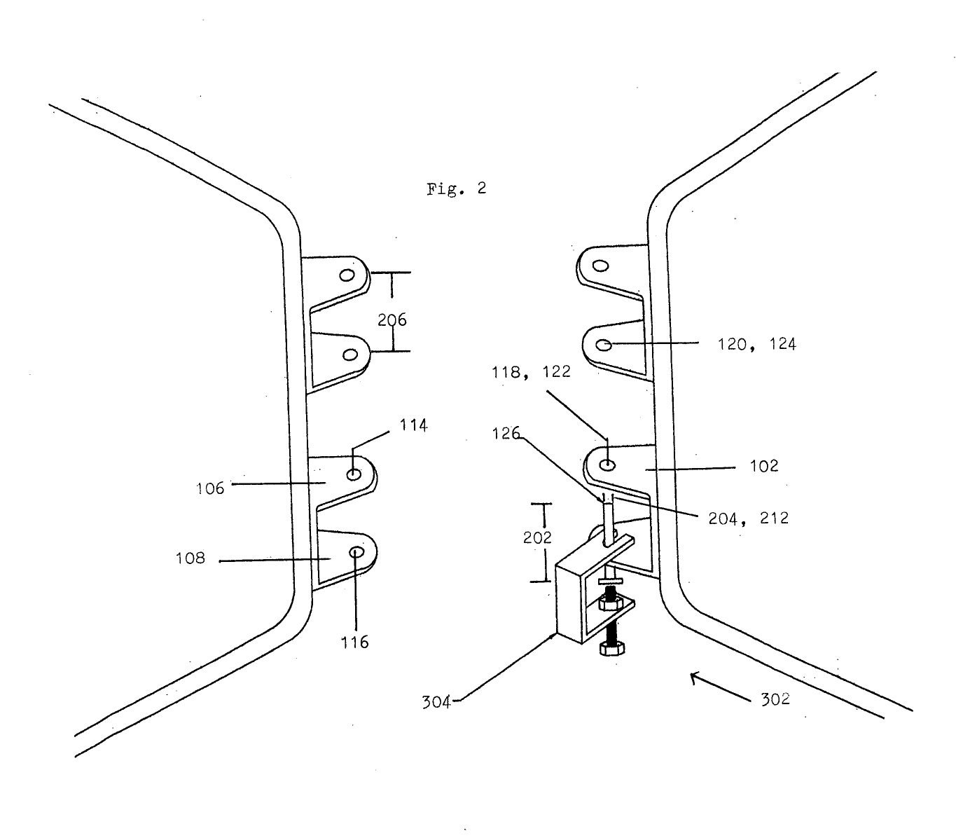

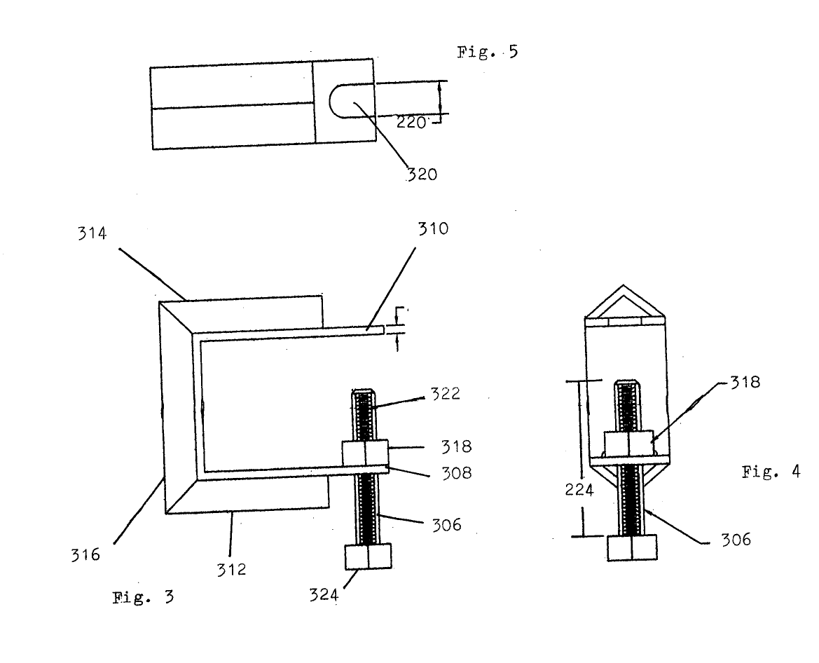

Hinge pin installation tool 302 has frame 304 which serves to hold the tool in place while force is applied via another draw bolt. FIG. 3 is a side view of the hinge pin installation tool of the invention. FIG. 4 is an end view of the hinge pin installation tool of the invention. FIG. 5 is a top view of the hinge pin installation tool of the invention. In the presently preferred embodiment and best mode presently contemplated for carrying out the invention, hinge pin draw bolt length 224 of hinge pin draw bolt 306 may be greater than the hinge pin length 224.

First end 308 on first arm 312 and second end 310 on second arm 314 are situated at opposite ends of cross piece 316. Each end has an aperture: first end 308 has threaded aperture 318 having the hinge pin draw bolt 306 threaded therein, while second end 310 has receiving aperture 320 passing through it. The diameter of second aperture 321 is greater than the hinge pin outer diameter 204.

Hinge pin draw bolt threaded end 322 acts on threaded aperture 318 when hinge pin draw bolt head end 324 is turned, forcing the hinge pin draw bolt upwards and thus forcing the hinge pin atop the draw bolt upwards as well.

It will be understood (referring to FIG. 2) that in use, a mechanic may easily turn the head end 324, causing the hinge pin draw bolt to draw the hinge pin through inner diameters of the bushings with reliability and great control over the process. To repeat, the extremely tight tolerances for the door hinge parts which the vehicle manufacturer must use in order to reliably support the cantilevered weight of a vehicle door make this an extremely difficult process without the kit of the invention.

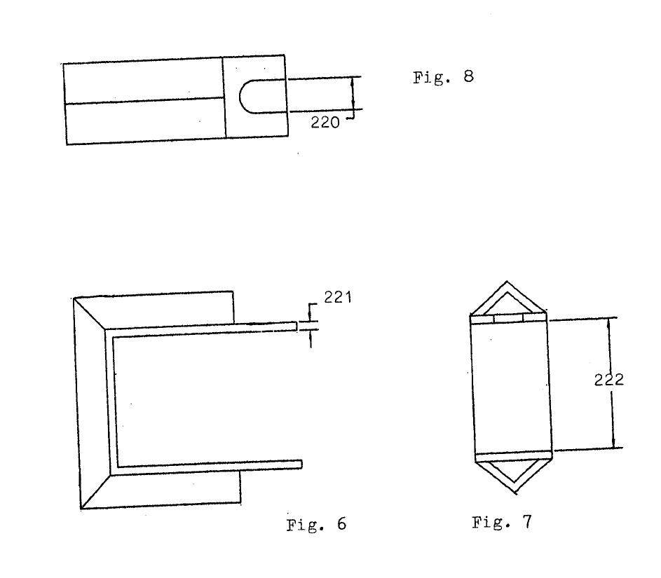

FIG. 6 is a side view of a second embodiment of the hinge pin installation tool of the invention, FIG. 7 is an end view of the second embodiment of the hinge pin installation tool of the invention, and FIG. 8 is a top view of the hinge pin installation tool of the invention in the second embodiment. These diagrams show the tool without the hinge pin draw bolt.

The arms and cross piece of the alternative embodiment have a triangular cross section Receiving aperture diameter 220 and hinge pin installation tool end separation distance 222 may be different from those of the first embodiment if the model or make of vehicle has different distances, however, the stated relationships of vehicle dimensions and hinge pin tool and bushing tool dimensions remain.

In this embodiment, the threaded aperture may be thinner than in the first embodiment: the thickness of both apertures may be approximately thickness 221.

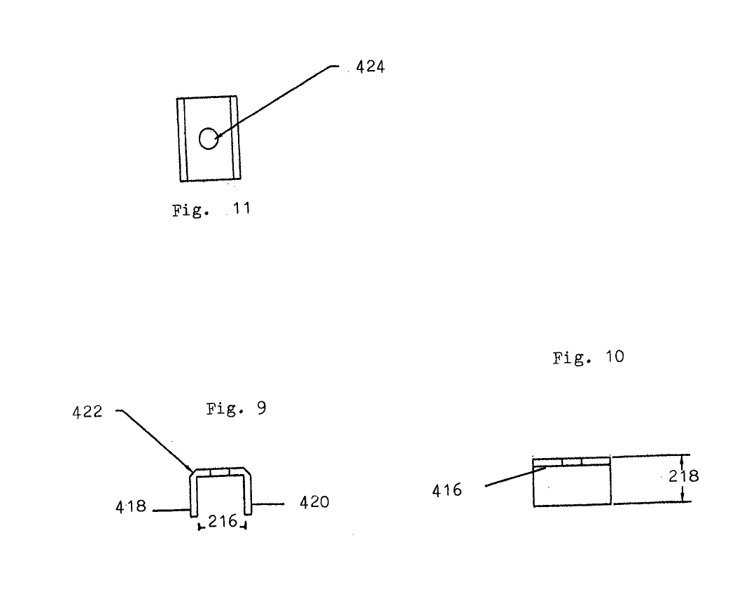

FIG. 9 is an end view of the truss piece of the bushing installation tool of the invention. FIG. 10 is a cross-sectional side view of the truss piece of the bushing installation tool of the invention. FIG. 11 is a bottom plan view of the truss piece of the bushing installation tool of the invention. Truss piece top portion 416 serves as the platform against which nut 408 and second washer 426 (if used) will push. Truss piece side portions 418, 420 hold the tool away from the hole through which a bushing will partially emerge, thus leaving room for the bushing to seat properly and fully into the hole. As noted, the dimensions of the various parts of the invention are important to allow proper functioning. Separation distance of truss side pieces 216 must be larger than the outer diameter of the bushing 210 (which is closely equivalent to hole diameter 208) for the same reason.

Top portion edges 422 may be the location for the side portions 418, 420. The top portion edges may also be chamfered. Top portion hole 424 allows the bushing draw bolt 404 to pass through to the nut. Truss piece height 218 must be somewhat less than the bracket support separation distance 206, to allow room for the assembly (including nut and washers) to be used within the bracket.

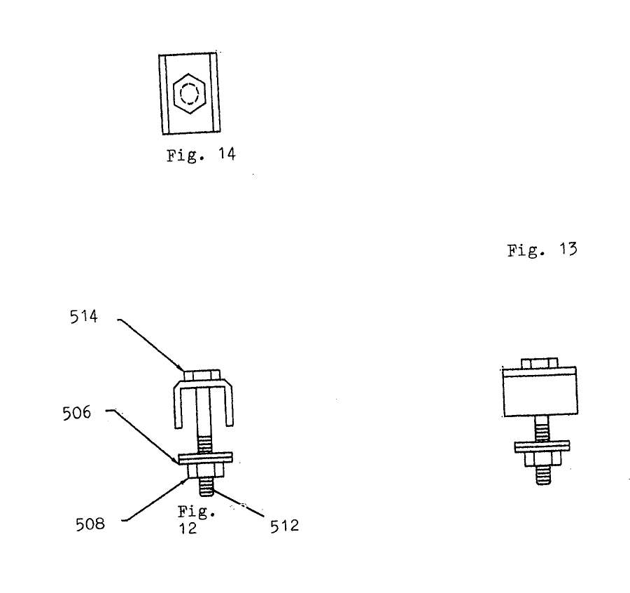

FIG. 12 is a front view of the assembled bushing installation tool of the invention in an alternative embodiment, while FIG. 13 is a side view of the assembled bushing installation tool of the alternative embodiment and FIG. 14 is a bottom view of the assembled bushing installation tool of the alternative embodiment.

In this embodiment, the bolt head end 514 sits on the truss piece while the nut 508 is used from the threaded end 512 to urge washer 506 against the bushing and thus force the bushing into the hole.

Exemplary dimensions of two embodiments designed for General Motors products are provided in Table I and Table II. These dimensions are exemplary only: the invention may be used with different dimensions optimized for use on other makes of vehicles. The invention is NOT limited to only these dimensions, rather the dimensions stated as operative relationships in the claims are important to the invention.

TABLE I
Hinge Pin Tool, dimensions in inches

| | |
|---|---|
| Cross piece length | 3.25 |
| Arm length | 2.625 |
| End thickness | 0.125 |
| Cross piece and arm width | 1.125 |
| Cross piece and arm construction | 0.75 angle iron and 1.25 × 0.25 plate |
| Receiving aperture diameter | 0.5 |
| Threaded aperture | 0.375 × no. 20 nut |
| Draw bolt | 0.375 × no. 20 × 2 bolt |
| Total internal length of arm | 3.0 |
| Total internal width | 2.0 |

TABLE II
Bushing Tool, dimensions in inches

| | |
|---|---|
| Truss piece width | 0.875 |
| Truss piece length | 1.000 |
| Truss piece height | .563 |
| Bushing draw bolt | 0.25 × no. 20 × 1.5 |
| Washer | 0.25 flat round |
| Nut | 0.25 |
| Hole width | 0.3 |

Testing has shown that this embodiment provides a convenient and careful apparatus for installation of bushings and hinge pins on General Motors products.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A custom hinge bushing and pin installation kit for use on a particular make of automobile hinge, the automobile hinge having an upper door support having a first hole therethrough, and having a lower door support having a second hole therethrough, and having an upper frame support having a third hole therethrough, and having a lower frame support having a fourth hole therethrough, and having an upper bushing having a fifth hole therethrough, and having a lower bushing having a sixth hole therethrough, and having at least one hinge pin having a hinge pin length and having an outer diameter, the upper and lower supports being separated by a first distance, the first and second holes having a first diameter, the upper and lower bushings having an outer diameter almost exactly equal to the first diameter, the upper and lower bushings having a inner diameter almost exactly equal to the outer diameter of the hinge pin, in which the hinge bushing and pin installation kit comprises:
a) a bushing installation tool having a bushing draw bolt, at least one flat washer; a nut, and a truss piece;
b) the bushing draw bolt having a threaded end and a head end;
c) the nut threaded upon the bushing draw bolt threaded end;
d) the at least one flat washer disposed around the bushing draw bolt between the nut and the head end, the flat washer having a diameter greater than the inner diameter of the bushings;
e) the truss piece having a top portion and two side portions extending from the edges of the top portion at an angle substantially perpendicular to the top portion, and having a hole passing through the top portion, the truss piece hole disposed around the bushing draw bolt between the at least one flat washer and the bushing draw bolt head, the truss piece disposed with the side portions extending towards the at least one flat washer;
f) the side portions of the truss piece being separated by a distance greater than the outer diameter of the two bushings; the truss piece height being shorter than the first distance between the upper and lower supports;
g) a hinge pin installation tool having a strong frame and a hinge pin draw bolt;
h) the strong frame having a first end having an internally threaded aperture and a second end having a receiving aperture, the receiving aperture having a diameter larger than the outer diameter of the hinge pin; the first and second ends being separated by a distance and
i) the hinge pin draw bolt having a threaded end and a head end, the threaded end threaded through the internally threaded aperture of the first end of the strong frame, the hinge pin draw bolt having a length greater than the hinge pin length.

2. The custom hinge bushing and pin installation kit of claim 1, wherein the strong frame further comprises:
h1) a first end arm terminating in the first end, a second end arm terminating in the second end, and a cross piece connecting the first and second end arms.

3. The custom hinge bushing and pin installation kit of claim 2, wherein the strong frame further comprises a triangular cross-section of steel construction along the first end arm, the second end arm and the cross piece.

4. A custom hinge bushing and pin installation kit for use on a particular make of automobile hinge, the automobile hinge having an upper door support having a first hole therethrough, and having a lower door support having a second hole therethrough, and having an upper frame support having a third hole therethrough, and having a lower frame support having a fourth hole therethrough, and having an upper bushing having a fifth hole therethrough, and having a lower bushing having a sixth hole therethrough, and having at least one hinge pin having a hinge pin length and having an outer diameter, the upper and lower supports being separated by a first distance, the first and second holes having a first diameter, the upper and lower bushings having an outer diameter almost exactly equal to the first diameter, the upper and lower bushings having a inner diameter almost exactly equal to the outer diameter of the hinge pin, in which the hinge bushing and pin installation kit comprises:
a) a bushing installation tool having a bushing draw bolt, at least one flat washer; a nut, and a truss piece;
b) the bushing draw bolt having a threaded end and a head end;
c) the truss piece having a top portion and two side portions extending from the edges of the top portion at an angle substantially perpendicular to the top portion, and having a threaded hole passing through the top portion, the truss piece threaded upon the bushing draw bolt at the bushing draw bolt threaded end, the truss piece disposed with the side portions extending towards the at least one flat washer;
d) the at least one flat washer disposed around the bushing draw bolt between the truss piece and the head end, the flat washer having a diameter greater than the inner diameter of the bushings;
e) the side portions of the truss piece being separated by a distance greater than the outer diameter of the two bushings; the truss piece being smaller than the first distance between the upper and lower supports;
f) a hinge pin installation tool having a strong frame and a hinge pin draw bolt;
g) the strong frame having a first end having an internally threaded aperture and a second end having a receiving aperture, the receiving aperture having a diameter larger than the outer diameter of the hinge pin; the first and second ends being separated by a distance and
h) the hinge pin draw bolt having a threaded end and a head end, the threaded end threaded through the internally threaded aperture of the first end of the strong frame, the hinge pin draw bolt having a length greater than the hinge pin length.
